(19) United States
(12) Patent Application Publication
(10) Pub. No.: US 2015/0064973 A1
(43) Pub. Date: Mar. 5, 2015

(54) CONNECTOR ASSEMBLY

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: YI-FANG WU, New Taipei (TW); KE CHEN, Shenzhen (CN)

(21) Appl. No.: 14/470,936

(22) Filed: Aug. 27, 2014

(30) Foreign Application Priority Data
Aug. 30, 2013 (CN) 201310386717X

(51) Int. Cl. H01R 13/502

(52) U.S. Cl. CPC H01R 13/502
USPC 439/626

(57) ABSTRACT

Connector assembly includes a connecting body and a protecting cover. The connecting body includes an accommodating portion. The accommodating portion defines a number of accommodating holes. The accommodating portion includes an accommodating body. The accommodating body includes two first sidewalls and two second sidewalls. At least one of the two first sidewalls defines a number of receiving openings. The protecting cover includes a top plate, a front plate extending from the top plate, and two side plates. The top plate, the front plate, and the two side plates cooperatively define an accommodating space. A number of cutouts are defined in the front plate. When the protecting cover covers the accommodating body, the cutouts are aligned to the receiving openings of one side of the accommodating space, and a number of cables can pass through the connector assembly via the number of cutouts and the number of receiving openings.

### CROSS-REFERENCE TO RELATED APPLICATIONS

This application claims priority to Chinese Patent Application No. 201310386717.X filed on Aug. 30, 2013 in the China Intellectual Property Office, the contents of which are incorporated by reference herein.

### FIELD

The subject matter herein generally relates to a connector assembly with a protecting cover.

### BACKGROUND

Connectors are widely used on printed circuit boards (PCBs) and cable assemblies. A connector can include an inserting portion and multiple connecting lines extending from the inserting portion. The multiple connecting lines can be exposed from the connector.

### BRIEF DESCRIPTION OF THE DRAWINGS

Implementations of the present technology will now be described, by way of example only, with reference to the attached figures, wherein:

FIG. 1 is an exploded perspective view of an embodiment of a connector assembly, the connector assembly comprising a protecting cover.

FIG. 2 is similar to FIG. 1, but viewed from another aspect.

FIG. 3 is an isometric perspective view of the protecting cover of FIG. 1.

FIG. 4 is an assembled perspective view of the connector assembly of FIG. 1.

FIG. 5 is an assembled perspective view of the connector assembly of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The present disclosure is described in relation to a connector assembly including a connecting body and a protecting cover. The connecting body includes an accommodating portion. The accommodating portion defines a number of accommodating holes. The accommodating portion includes an accommodating body. The accommodating body includes two first sidewalls and two second sidewalls. At least one of the two first sidewalls defines a number of receiving openings. The protecting cover includes a top plate, a front plate extending from the top plate, and two side plates. The top plate, the front plate, and the two side plates cooperatively define an accommodating space. A number of cutouts are defined in the front plate. When the protecting cover covers the accommodating body, the cutouts are aligned to the receiving openings of one side of the accommodating space, and a number of cables can pass through the connector assembly via the number of cutouts and the number of receiving openings.

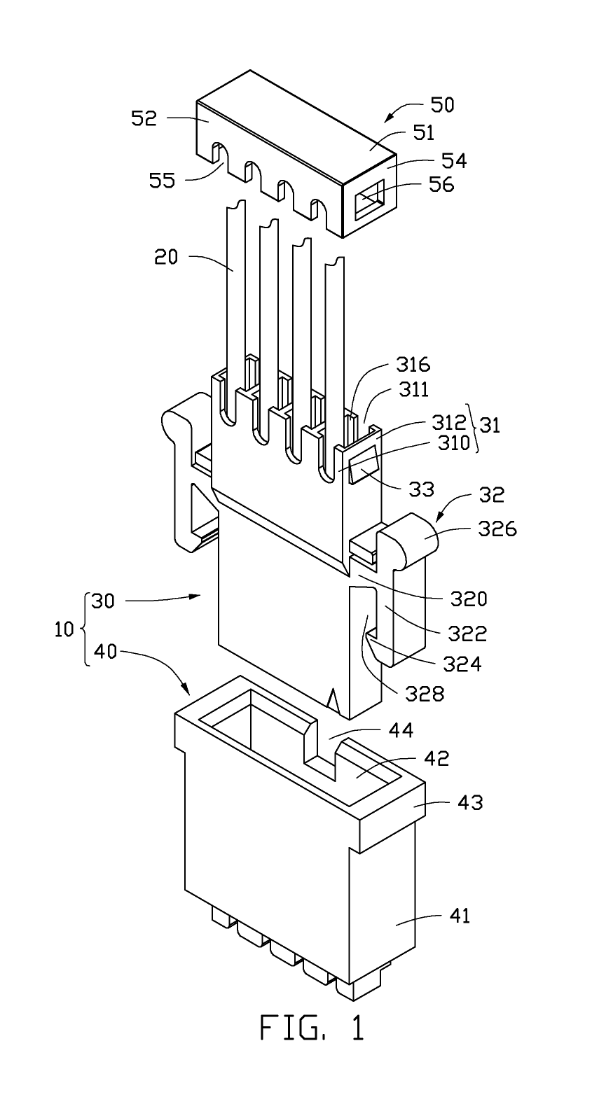

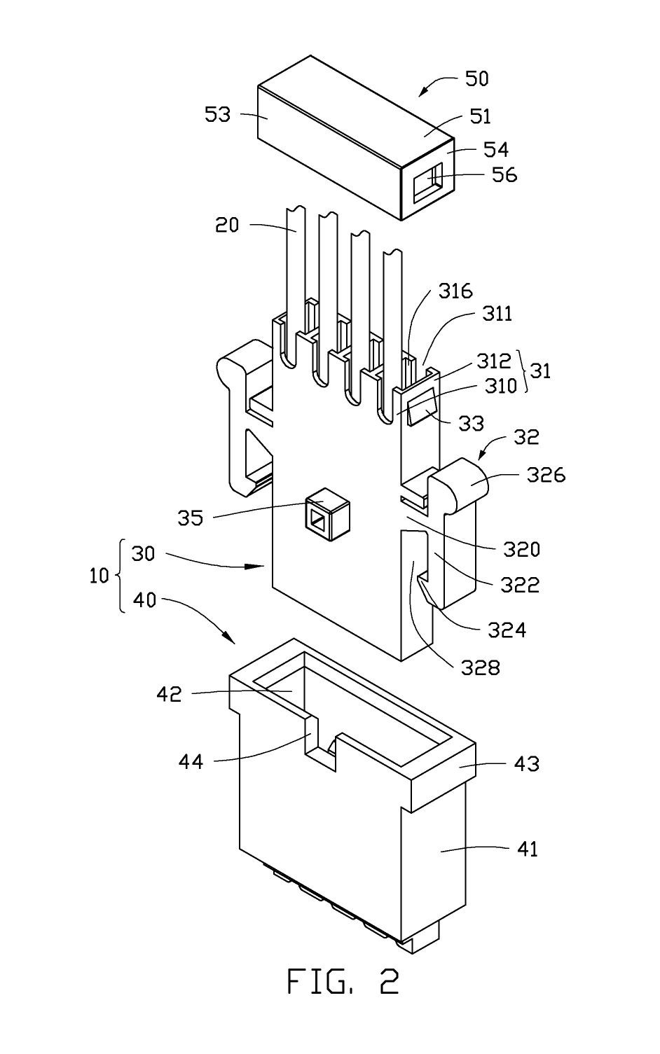

FIGS. 1 and 2 illustrate an embodiment of a connector assembly. The connector assembly includes a connecting body 10, and a protecting cover 50 mounted to the connecting body 10.

The connecting body 10 includes an accommodating portion 30 and an inserting portion 40. The accommodating portion 30 includes an accommodating body 31, two clamping blocks 32, two locking blocks 33, and a stopping block 35. The accommodating body 31 includes two first sidewalls 310, and two second sidewalls 312 substantially perpendicularly connected to the two first sidewalls 310. One clamping block 32 and one locking block 33 are located on one second sidewall 312, and the other clamping block 32 and the other locking block 33 are located on the other second sidewall 312. The stopping block 35 protrudes from one of the two first sidewalls 310. In one embodiment, the two first sidewalls 310 are substantially parallel to each other, and the two second sidewalls 312 are substantially parallel to each other.

A number of receiving openings 311 and a number of accommodating holes 316 are defined in the accommodating portion 30. The accommodating holes 316 extend all the way through opposite ends of the accommodating portion 30, and the receiving openings 311 are defined in top portions of the two first sidewalls 310. The receiving openings 311 extend to the corresponding accommodating holes 316. In the illustrated embodiment, two receiving openings 311, one defined in each sidewall 310, correspond to each accommodating hole 316. The accommodating holes 316 are configured to receive a number of cables 20.

Each clamping block 32 includes an elastic portion 320 substantially perpendicularly extending from the corresponding second sidewall 312, a connecting portion 322 substantially perpendicularly connected to the elastic portion 320, a hook portion 324 extending toward the corresponding second sidewall 312 from the connecting portion 322, and an operation portion 326 extending from the connecting portion 322. In one embodiment, the connecting portions 322 are substantially parallel to the two second sidewalls 312. A receiving slot 328 is defined between the connecting portion 322 and the corresponding second sidewall 312.

The inserting portion 40 includes a connecting body 41, and two resisting blocks 43 extending from the connecting body 41. One resisting block 43 extends from one side of the connecting body 41, and the other resisting block 43 extends from the other side of the connecting body 41. A receiving space 42 is defined in the connecting body 41. The receiving space 42 extends all the way through opposite ends of the connecting body 41. A resisting opening 44 is defined in an upper portion of one side of the connecting body 41. The resisting opening 44 extends to the receiving space 42.

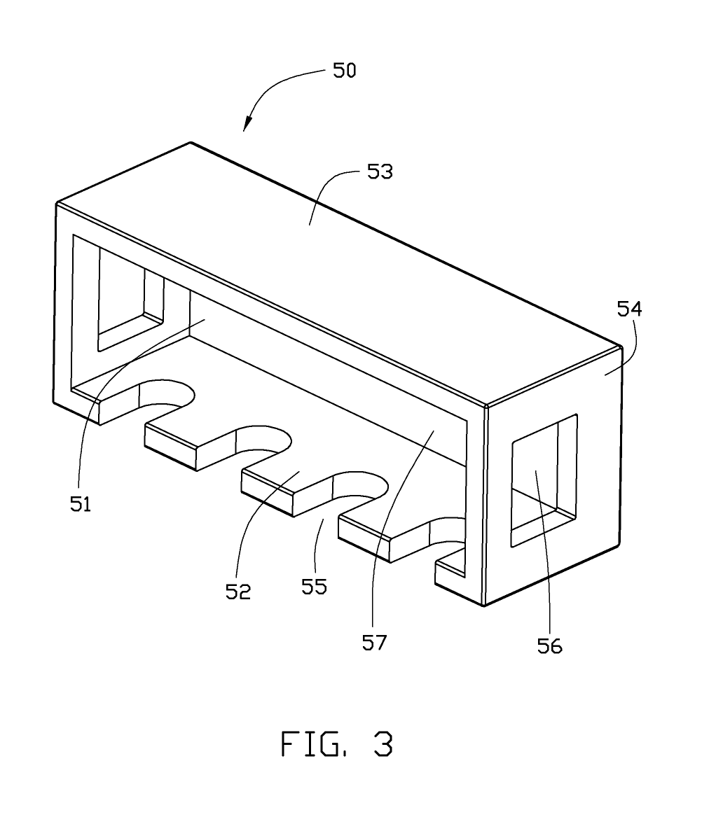

FIG. 3 illustrates that the protecting cover 50 includes a top plate 51, a front plate 52, a back plate 53 substantially perpendicularly connected to the top plate 51, and two side plates 54 substantially perpendicularly connected to the front plate 52 and the back plate 53. A number of cutouts 55 is defined in the front plate 52. Each cutout 55 corresponds to one of the receiving openings 311. A locking hole 56 is defined in each side plate 54. Each locking hole 56 corresponds to one of the two locking blocks 33. An accommodating space 57 is defined between the front plate 52 and the back plate 53. Each cutout 55 extends to the accommodating space 57.

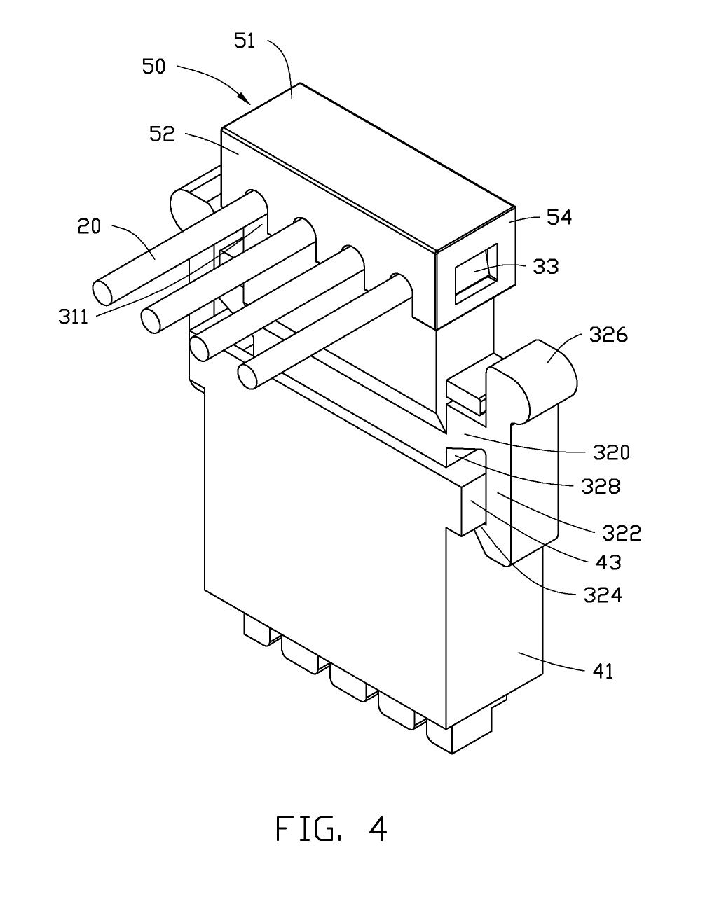

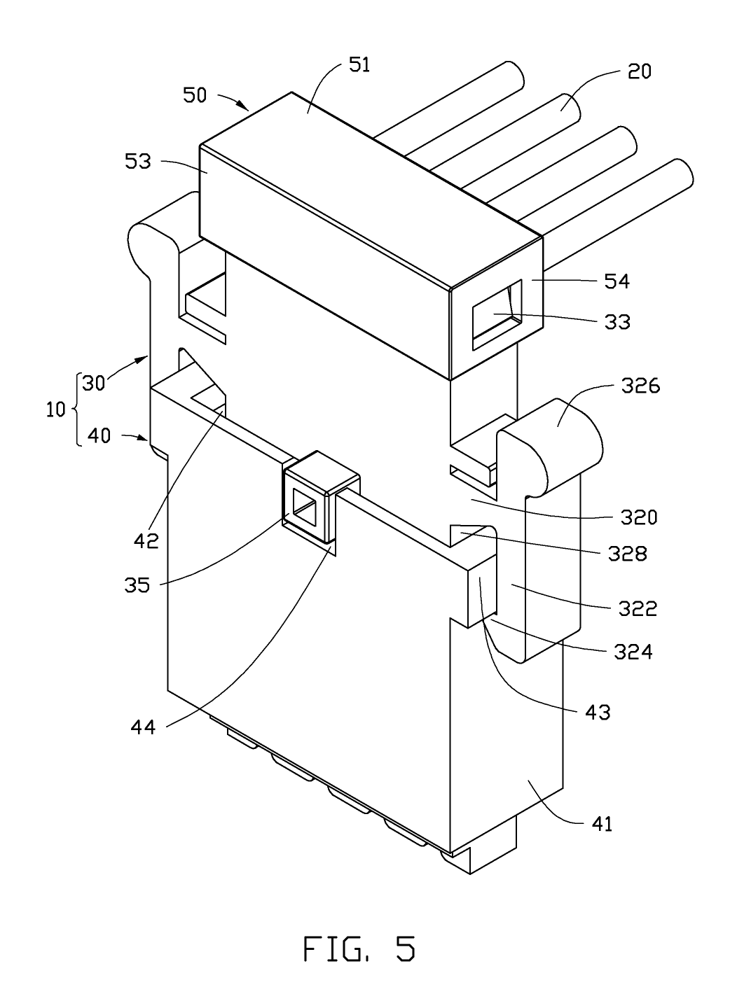

Referring to FIGS. 4 and 5, in assembly, the accommodating body 31 of the accommodating portion 30 is first partially received into the receiving space 42 of the inserting portion 40. The operation portions 326 of the two clamping blocks 32 are pressed toward the two second sidewalls 312, causing the elastic portions 320 to elastically deform and move the hook portions 324 away from the two second sidewalls 312. The accommodating body 31 is further received into the receiving space 42 until the hook portions 324 pass over the corresponding resisting blocks 43. The resisting blocks 43 are received in the corresponding receiving slots 328. The operation portions 326 are released, causing the elastic portions 320 to elastically return to the original positions. When the elastic portions 320 elastically return, the hook portions 324 latch to the corresponding resisting blocks 43.

The stopping block 35 is received in the resisting opening 44 and resists against a bottom edge of the resisting opening 44. The cables 20 are inserted into the corresponding accommodating holes 316. The cables 20 are bent to pass through the corresponding receiving openings 311. The protecting cover 50 covers the accommodating portion 30, such that a portion of the accommodating portion 30 is received in the accommodating space 57.

The locking blocks 33 protrude through the corresponding locking holes 56 of the protecting cover 50, thereby latching the protecting cover 50 to the accommodating portion 30. When the protecting cover 50 is assembled to the accommodating portion 30, the cutouts 55 are aligned to the receiving openings 311 of one first sidewall 310. The cables 20 extend out of the protecting cover 50 via the corresponding receiving openings 311 and the corresponding cutouts 55.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A connector assembly, comprising:
a connecting body comprising an accommodating portion; wherein the accommodating portion defines a number of accommodating holes configured to receive a number of cables; the accommodating portion comprises an accommodating body; the accommodating body comprises two first sidewalls and two second sidewalls connected to the two first sidewalls; at least one of the two first sidewalls defines a number of receiving openings; each receiving opening extends to one of the accommodating holes; and
a protecting cover comprising a top plate, a front plate extended from the top plate, and two side plates connected to the front plate; wherein an accommodating space is defined between the front plate and the back plate; a number of cutouts are defined in the front plate corresponding to the number of receiving openings; the number of cutouts extend to the accommodating space;
wherein the number of cables are bend and received in the number of receiving openings; the number of cutouts are aligned to the number of receiving openings; and the number of cables extend out from the protecting cover via the number of receiving openings and the number of cutouts.

2. The connector assembly of claim 1, wherein the number of accommodating holes extend through the accommodating body.

3. The connector assembly of claim 1, wherein the accommodating portion further comprises two locking blocks extended from the corresponding second sidewalls; a locking hole is defined in each side plate corresponding to one of the two locking blocks; and the two locking blocks are locked in the corresponding locking holes.

4. The connector assembly of claim 3, wherein the connecting body further comprises an inserting portion connected to the accommodating portion; a receiving space is defined in the inserting portion and extends through the connecting body; and the accommodating portion is received in the receiving space.

5. The connector assembly of claim 4, wherein the connecting body further comprises a stopping block protruding from one of the two first sidewalls; a resisting opening is defined in the connecting body; the resisting opening extends to the receiving space; and the stopping block is received in the resisting opening and resists against the resisting opening.

6. The connector assembly of claim 4, wherein the inserting portion comprises a connecting body and two resisting blocks extended from the connecting body; the accommodating portion further comprises two clamping blocks extended from the two second sidewalls respectively; and the two clamping blocks are locked on the two resisting blocks respectively.

7. A connector assembly, comprising:
a connecting body comprising an accommodating portion; wherein the accommodating portion defines a number of accommodating holes; the accommodating portion comprises an accommodating body; the accommodating body comprises two first sidewalls and two second sidewalls connected to the two first sidewalls; at least one of the two first sidewalls defines a number of receiving openings; each receiving opening extends to one of the number of accommodating holes; and
a protecting cover comprising a top plate, a front plate extended from the top plate, and two side plates connected to the front plate; wherein an accommodating space is defined between the front plate and the back plate; a number of cutouts are defined in the front plate corresponding to the number of receiving openings; the number of cutouts extend to the accommodating space;
wherein when the protecting cover covers the accommodating body, the number of cutouts are aligned to the number of receiving openings, and one side of the accommodating space can be accessed from out of the connector assembly via the number of cutouts and the number of receiving openings.

8. The connector assembly of claim 7, wherein the number of accommodating holes extend through the accommodating body.

9. The connector assembly of claim 7, wherein the accommodating portion further comprises two locking blocks extended from the corresponding second sidewalls; a locking hole is defined in each side plate corresponding to one of the two locking blocks; and the two locking blocks are locked in the corresponding locking holes.

10. The connector assembly of claim 9, wherein the connecting body further comprises an inserting portion connected to the accommodating portion; a receiving space is defined in the inserting portion and extends through the connecting body; and the accommodating portion is received in the receiving space.

11. The connector assembly of claim 10, wherein the connecting body further comprises a stopping block protruding from one of the two first sidewalls; a resisting opening is defined in the connecting body; the resisting opening extends to the receiving space; and the stopping block is received in the resisting opening and resists against the resisting opening.

12. The connector assembly of claim 10, wherein the inserting portion comprises a connecting body and two resisting blocks extended from the connecting body; the accommodating portion further comprises two clamping blocks extended from the two second sidewalls respectively; and the two clamping blocks are locked on the two resisting blocks respectively.
